(19) United States
(12) Patent Application Publication
(10) Pub. No.: US 2011/0024245 A1
(43) Pub. Date: Feb. 3, 2011

(54) Shock absorber

(75) Inventors: Takashi Nezu, Kanagawa (JP); Atsufumi Ishimoto, Kanagawa (JP); Shigeo Katayama, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Hitachi Automotive Systems, Ltd., Kanagawa (JP)

(21) Appl. No.: 12/805,313

(22) Filed: Jul. 26, 2010

(30) Foreign Application Priority Data
Jul. 31, 2009 (JP) 2009-179933

(51) Int. Cl. F16F 9/32

(52) U.S. Cl. 188/283

(57) ABSTRACT

A shock absorber comprising: a cylinder; a piston partitioning the cylinder into two chambers; a piston rod; a by-pass passage passing through the chambers; and a damping-force adjusting mechanism adjusting a passage area of the by-pass passage, wherein the adjusting mechanism includes: a shutter guide; a shutter movably guided by the shutter guide; and an elastic member elastically retaining the shutter at an initial position, an adjustable passage adjusting the passage area of the by-pass passage as that opening is varied by shift of the shutter is formed, shift of the shutter is not influenced by pressure difference between the chambers, and when the shutter is at the initial position, the adjustable passage is opened with a predetermined degree, and the shutter moves to close the adjustable passage by fluid force that generates by flow of the working fluid of the adjustable passage against elastic force of the elastic member.

### BACKGROUND OF THE INVENTION

1. Field of the Invention

The present invention relates to a shock absorber that is adjustable in damping force.

2. Description of the Related Art

In a shock absorber that is mounted on the suspension device of a vehicle, etc., it has been well known that damping force properties of the shock absorber are made to be adjustable. According to the traveling condition of the vehicle, the damping force properties are properly switched over so as to improve operational stabilities and riding qualities

Japanese Patent Publication Laid-open Hei 05-302639 (hereinafter to be referred to as the patent Document) discloses a shock absorber where according to stroke frequencies of a piston rod, damping force is set to low relative to high-frequency strokes by the unsprung vibration of a suspension device while the damping force is set to high relative to low-frequency strokes by the sprung vibration of the suspension device. Accordingly, it becomes possible to absorb irregularity on a road surface so as to reduce the postural deviation of a vehicle body when accelerating/decelerating or when rotating whereby riding qualities and operational stabilities can be improved.

However, the shock absorber discussed in the patent Document has the following problems. That is, in the shock absorber, for adjusting damping force according to the stroke frequencies of the piston rod, the valve body of a damping-force adjusting mechanism is shifted by a pressure difference between two chambers in a cylinder that is partitioned by a piston, and when the valve body is shifted to a predetermined position, the opening of a passage for working fluid is altered. Accordingly, at an initial stage where the piston rod strokes, the flow of the working fluid that is generated by slide of the piston within the cylinder is consumed by the shift of the valve body whereby damping force to be desired is not obtainable. The damping force generated when the piston rod performs slight strokes at high-frequency thus tends to fail, and at low-frequency, the generation of the damping force tends to be unstable due to late response of the damping force.

### SUMMARY OF THE INVENTION

The present invention has been made in the light of the above problems, and it is an object of the present invention to provide a shock absorber that is adjustable in damping force according to the stroke frequencies of a piston rod so as to improve responsibility of the damping force and obtain stable damping force properties.

In order to achieve the object described above, according to a first aspect of the present invention, there is provided a shock absorber comprising: a cylinder where working fluid is filled in; a piston that is slidably inserted into the cylinder and partitions the cylinder into two chambers; a piston rod that is connected with the piston and externally projects from the cylinder; a by-pass passage that passes through the two chambers in the cylinder; and a damping-force adjusting mechanism that adjusts a passage area of the by-pass passage, wherein the damping-force adjusting mechanism includes: a shutter guide provided at the piston rod; a shutter that is movably guided by the shutter guide; and an elastic member that elastically retains the shutter at an initial position, an adjustable passage that adjusts the passage area of the by-pass passage as that opening is varied by shift of the shutter is formed, shift of the shutter is not influenced by pressure difference between the two chambers in the cylinder, and when the shutter is at the initial position, the adjustable passage is opened with a predetermined degree, and the shutter moves in a direction to close the adjustable passage by means of fluid force that generates by flow of the working fluid of the adjustable passage against elastic force of the elastic member.

Further, according to a second aspect of the present invention, there is provided a shock absorber comprising: a cylinder where working fluid is filled in; a piston that is slidably inserted into the cylinder and partitions the cylinder into two chambers; a piston rod that is connected with the piston and externally projects from the cylinder; a by-pass passage that passes through the two chambers in the cylinder; and a damping-force adjusting mechanism that adjusts a passage area of the by-pass passage, wherein the damping-force adjusting mechanism includes a shutter that shifts on a passage of the by-pass passage so as to open or close the passage, and the shutter is not externally controlled, is not influenced in movement by pressure difference between the two chambers in the cylinder, and moves by fluid force that is generated by flow of the working fluid.

### BRIEF DESCRIPTION OF THE DRAWINGS

FIG. 1 is the longitudinal sectional view of a damping-force adjusting mechanism that is the main feature of a shock absorber according to a first aspect of the present invention;

FIG. 2 is the longitudinal sectional view of the shock absorber of FIG. 1;

FIGS. 3A to 3C show working conditions of the damping-force adjusting mechanism of FIG. 1;

FIG. 4 is the longitudinal sectional view of a damping-force adjusting mechanism that is the main feature of a shock absorber according to a second aspect of the present invention;

FIG. 5 is the longitudinal sectional view of a damping-force adjusting mechanism that is the main feature of a shock absorber according to a third aspect of the present invention, the damping-force adjusting mechanism being taken along the line C-C in FIG. 6(B);

FIGS. 6A and 6B are the cross sectional views of the damping-force adjusting mechanism taken along the lines A-A and B-B;

FIG. 7 is a graph that shows damping force properties of the shock absorber of FIG. 1; and

FIG. 8 is a Bode diagram that shows frequency properties of the shock absorber of FIG. 1.

### DETAILED DESCRIPTION OF THE PREFERRED EMBODIMENTS

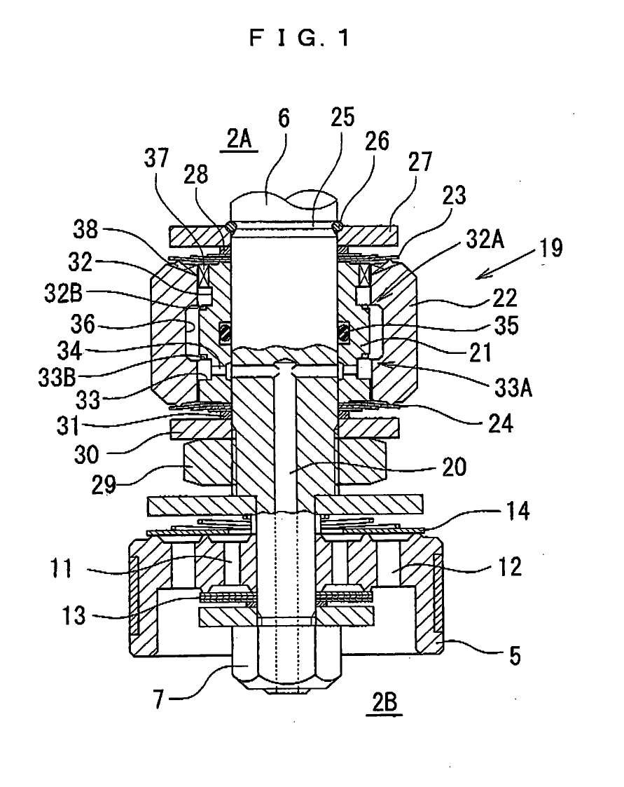

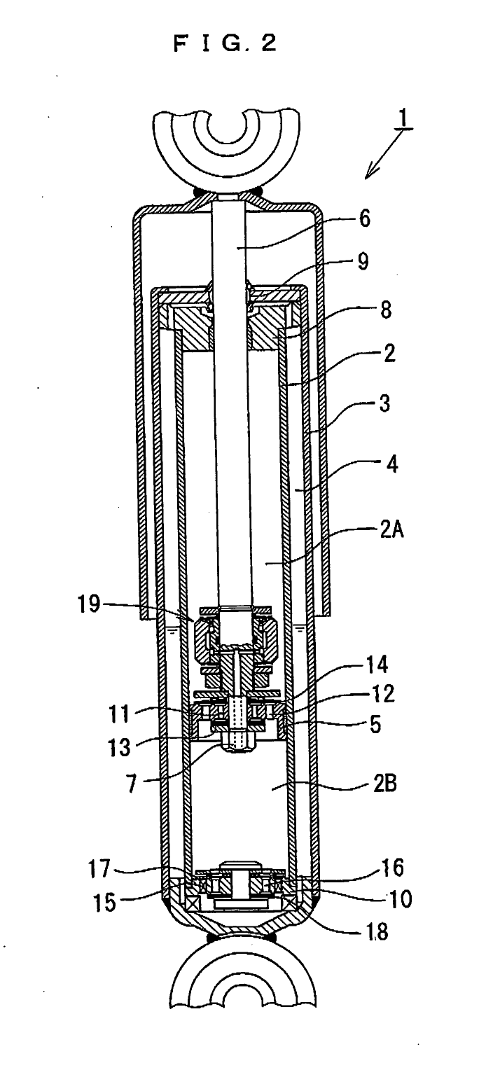

Embodiments of the present invention will be explained in detail with reference to the attaching figures. A first embodiment of the present invention will be explained with reference to FIGS. 1 to 3. As shown in FIGS. 1 and 2, a shock absorber 1 of the present embodiments is categorized into a so-called double-tube shock absorber where an external cylinder 3 is provided at the external periphery of a cylinder 2, and an annular reservoir 4 is formed between the cylinder 2 and the external cylinder 3. Accordingly, the shock absorber 1 is formed into a dual-cylindrical structure. Within the cylinder 2, a piston 5 is slidably inserted. The piston 5 partitions the cylinder 2 into two chambers, that is, a cylinder upper chamber 2A and a cylinder lower chamber 2B. At the piston 5, one end of a piston rod 6 is connected through a nut 7, and the other end of the piston rod 6 penetrates a rod guide 8 and an oil seal 9 provided at the upper end portion of the cylinder 2 and the external cylinder 3 slidably and liquid-tightly so that the other end externally projects. At the lower end portion of the cylinder 2, a base valve 10 is provided so as to partition the cylinder lower chamber 2B and the reservoir 4, and hydraulic liquid as working fluid is filled in. Within the reservoir 4, the hydraulic fluid and gas are filled in.

At the piston 5, a first extension passage 11 and a first compression passage 12 are provided so as to connect between the cylinder upper and lower passages 2A, 2B. At the first extension passage 11, an extension disk valve 13 that generates damping force by controlling flow of the working fluid from a side of the cylinder upper chamber 2A to a side of the cylinder lower chamber 2B is provided. On the other hand, at the first compression passage 12, a first compression disk valve 14 that generates damping force by controlling flow of the working fluid from a side of the cylinder lower chamber 2B to a side of the cylinder upper chamber 2A is provided.

At the base valve 10, a second extension passage 15 and a second compression passage 16 are provided so as to connect the cylinder lower chamber 2B and the reservoir 4. At the second extension passage 15, a check valve 17 that allows only flow of the working fluid from a side of the reservoir 4 to a side of the cylinder lower chamber 2B is provided while at the second compression passage 16, a second compression disk valve 18 that generates damping force by controlling flow of the working fluid from a side of the cylinder lower chamber 2B to a side of the reservoir 4 is provided.

At the end portion of the piston rod 6 within the cylinder upper chamber 2A, a damping-force adjusting mechanism 19 is provided at a portion that is adjacent to the piston 5. Hereinbelow, the damping-force adjusting mechanism 19 will be explained with reference to FIG. 1. As shown in FIG. 1, at the interior of the end portion of the piston rod 6 that penetrates the piston 5, a by-pass passage 20 is provided along the axis of the piston rod 6. Considering the by-pass passage 20, one end portion thereof opens toward the interior of the cylinder lower chamber 2B while the other end portion thereof extends in a radial direction so as to open toward a side of the cylinder upper chamber 2A on the lateral surface of the piston rod 6, whereby the by-pass passage 20 is adapted to by-pass the first extension passage 11 and the first compression passage 12 of the piston 5 so as to connect the cylinder upper chamber 2A with the cylinder lower chamber 2B.

At the external periphery of the piston rod 6 within the cylinder upper chamber 2A, a cylindrical shutter guide 21 that is adjacent to the piston 5 is fitted and fixed. At the external periphery of the shutter guide 21, a cylindrical shutter 22 is slidably fitted. The shutter 22 is elastically retained by means of disk-shaped leaf springs 23, 24 made of an elastic member that are each fixed at either end side of the shutter guide 21. Considering the shutter guide 21 and the leaf springs 23, 24 provided on each end portion of the shutter guide 21, one end side of the shutter guide 21 and the leaf spring 23 are axially positioned by means of a stop ring 26 fitted in an outer periphery groove 25 of the piston rod 6 through a washer 27 and a retainer 28 while the other end side of the shutter guide 21 and the leaf spring 24 are fixed in such a manner that a nut 29 screwed in the threaded portion formed on the outer periphery of the piston rod 6 axially positions a washer 30 and a retainer 31. Here, it is possible to fix the shutter guide 21 and the leaf springs 23, 24 placed on both sides of the shutter guide 21 by means of the nut 7 together with the piston 5 without being provided with the nut 29 and the washer 30.

An extended guide groove 32 and a compressed guide groove 33 as outer periphery grooves are formed on the shutter guide 21. The compressed guide groove 33 is connected to the opening of the by-pass passage 20 positioned on the lateral surface of the piston rod 6 by means of a path 34 that penetrates the lateral wall of the shutter guide 21. Here, the connected portion between the pass 34 and the by-pass passage 20 is sealed on a side of the cylinder upper chamber 2A through claming pressure of an O-ring 35 and the nut 29 provided between the piston rod 6 and the shutter guide 21.

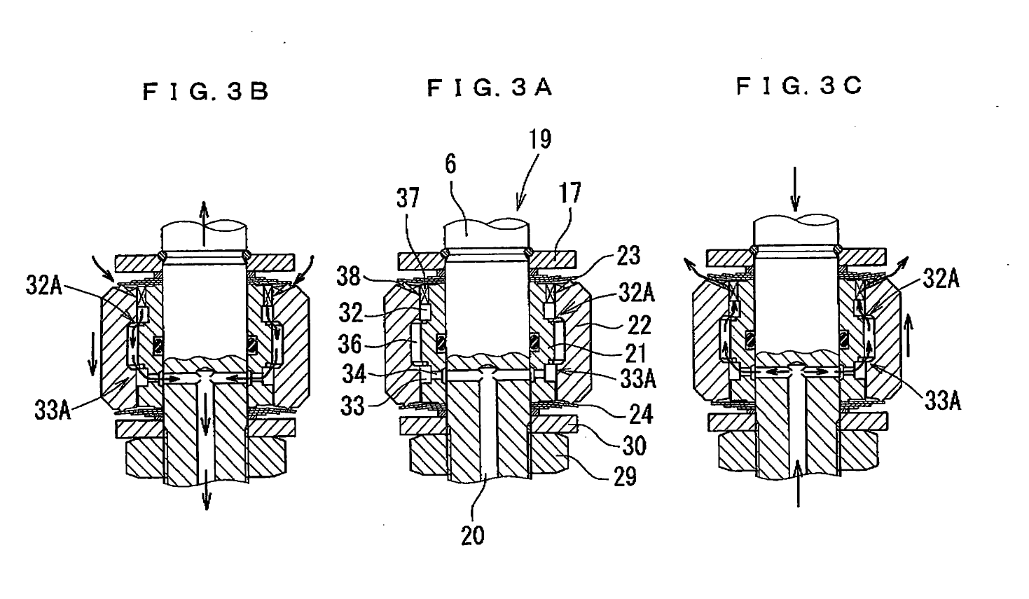

The shutter 22 is provided with a shutter groove 36 that functions as an outer peripheral groove. The width of the shutter groove 36 in an axial direction is set to be larger than a width defined between the extended guide groove 32 and the compressed guide groove 33 of the shutter guide 21. Further, in a condition where the shutter 22 is placed at an initial position as shown in FIG. 1, the shutter groove 36 is adapted to open so as to connect with both the extended guide groove 32 and the compressed guide groove 33. Then, by making the shutter 22 moved downward as shown in FIG. 3(B), an adjustable extension passage 32A provided between the extended guide groove 32 and the shutter groove 36 is drawn so as to adjust its passage area. Here, an adjustable compression passage 33A provided between the compressed guide groove 33 and the shutter groove 36 remains opened. On the other hand, by making the shutter 22 moved upward as shown in FIG. 3(C), the adjustable compression passage 33A provided between the compressed guide groove 33 and the shutter groove 36 is drawn so as to adjust its passage area. At this time, the adjustable extension passage 32A remains opened. At the marginal portions of the extended guide groove 32 and the compressed guide groove 33, notches 32B, 33B are formed so as to adjust a variation amount of the passage areas of the adjustable extension passage 32A and the adjustable compression passage 33A relative to strokes of the shutter 22. At the end portions of the shutter guide 21 and the shutter 22 (side of the extended guide groove 32), grooves 37, 38 are provided so as to normally connect the extended guide groove 32 with the cylinder upper chamber 2a.

The leaf springs 23, 24 are formed as that a plurality of disks with different diameters are laminated. The leaf springs 23, 24 abuts to annular convex portions that are formed on either end portion of the shutter 22 whereby the leaf springs 23, 24 elastically retain the shutter 22 at an initial position as shown in FIG. 1 while making the shutter 22 movable against the spring force thereof. Further, by means of friction generated by the laminated disks, the leaf springs 23, 24 also works as a damping means that applying damping force relative to the shift of the shutter 22. Here, these leaf springs 23, 24 are adapted to bend in an initial condition and elastically retain the shutter 22 with a predetermined initial load. Each element of a mass, spring and a damper based on a single-degree-of-freedom vibrating system can be defined by the mass of the shutter 22 and the spring force and frictional force of the leaf springs 23, 24.

Next, functions of the above embodiments will be explained. While the piston rod 6 is extending, working fluid on a side of the cylinder upper chamber 2A is pressurized by means of slide of the piston 5 within the cylinder 2. Thus, the working fluid flows toward the cylinder lower chamber 2B passing through grooves 37, of the damping-force adjusting mechanism 19, the extended guide groove 32, the shutter groove 36, the compressed guide groove 33, the path 34 and the by-pass passage 20. Here, damping force based on orifice properties will be generated due to the flow area of the adjustable extension passage 32A placed between the extended guide groove 32 and the shutter groove 36. Further, when pressure of the working fluid on a side of the cylinder upper chamber 2A reaches to pressure to open the extension disk valve 13 of the piston 5 along with increase of a piton speed, the extension disk valve 13 is opened. Accordingly, the working fluid in the cylinder upper chamber 2A flows toward the cylinder lower chamber 2B passing through the first extension passage 11, so that damping force based on valve properties will be generated according to opening of the extension disk valve 13. At this time, the check valve 17 of the base valve 10 is opened, and the working fluid only for an amount where the piston rod 6 is pulled out from the cylinder 2 flows into the cylinder lower chamber 2B by passing from the reservoir 4 to the second extension passage 15.

On the other hand, while the piston rod 6 is compressed, working fluid on a side of the cylinder lower chamber 2B is pressurized by means of slide of the piston 5 within the cylinder 2. Accordingly, the working fluid flows into the cylinder upper chamber 2A by passing thorough the by-pass passage 20 of the damping-force adjusting mechanism 19, the path 34, the compressed guide groove 33, the shutter groove 36, the extended guide groove 32 and the grooves 37, 38. Here, damping force of orifice properties will be generated due to the flow area of the adjustable compression passage 33A placed between the compressed guide groove 33 and the shutter groove 36. Further, when pressure of the working fluid on a side of the cylinder lower chamber 2B reaches to pressure to open the first compression disk valve 14 of the piston 5 along with increase of piston speed, the first compression disk valve 14 is opened, so that the working fluid on a side of the cylinder lower chamber 2B flows into the cylinder upper chamber 2A by passing through the first compression passage 12. Thus, damping force based on valve properties will be generated according to opening of the first compression disk valve 14. At this time, the working fluid only for an amount where the piston rod 6 is inserted into the cylinder 2 flows from the cylinder lower chamber 2B to the second compression passage 16 by opening the second compression disk valve 18 of the base valve 10. The working fluid then flows to the reservoir 4 so as to compress gas in the reservoir 4.

At the initial condition of the damping-force adjusting mechanism 19, the shutter 22 is elastically retained by means of the leaf springs 23, 24 at an initial position as shown in FIG. 3(A). When the piston rod 6 is extended, working fluid flows from the extended guide groove 32 to the compressed guide groove 33 passing through the shutter groove 36 whereby flow area will be drawn by means of the adjustable extension passage 32A placed between the extended guide groove 32 and the shutter groove 36, and the adjustable compression passage 33A placed between the shutter groove 36 and the compressed guide groove 33. Thus, flow speed is enhanced so as to generate jet streams. These jet streams will generate fluid force that makes the shutter 22 shifted in a direction of shutting the passage; however, during the extension process, in a direction where the working fluid flows, fluid force generated at the adjustable extension passage 32A becomes larger than liquid fluid generated at the adjustable compression passage 33A. Accordingly, due to the difference of the liquid force, the shutter 22 shifts downward as shown in FIG. 3(B) against the spring force of the leaf springs 23, 24 so as to close the adjustable extension passage 32A.

Here, the fluid force F working on the shutter 22 can be defined by the following Formula (I): F=−p·Q·V·cos θ±p·L1·Q′−mf·X″ where p is a working fluid density, Q is a flow rate, V is a jet speed, Q is a jet angle, L1 is a distance from an inflow point to an output point, mf is working fluid mass in a shutter groove, and X is the displacement of a shutter. According to Formula (I), the first term represents steady flow force. This steady flow force occurs as that pressure fall due to increase of flow speed defined by the Bernoulli's principle will be distributed to each portion on the surface of the shutter 22 along with variation of pressure whereby unbalanced force in a movable direction due to the pressure distribution will cause the steady flow force. Further, the steady flow force will be proportional to product of mass flow of working fluid that flows at a drawing portion and component in a tangent direction of jet stream speed. The second term represents non-steady flow force. Here, referential number indicates positive when flown out from the shutter groove 36 and negative when flown thereinto. The third term represents inertial force of the working fluid. The second and third terms occur according to variation of flow of the working fluid or opening of the drawing portion. These terms may be ignored since these are notably small compared to the steady flow force of the first term.

The steady flow force will normally act to close flow passage to the shutter 22. On the other hand, at an initial condition, the shutter 22 is elastically retained by the spring force of the leaf springs 23, 24 at initial position. Accordingly, when flow force occurs, the shutter 22 will shift in a direction to close flow passage up to a position where the steady flow force equilibrates the spring force of the leaf springs 23, 24. According to Formula (I), it can be said that the steady flow force is proportional to the flow speed of the working fluid, that is, proportional to stroke speed of the piston rod 6.

Shift of the shutter 22 is influenced by mass of a single-degree-of-freedom vibrating system, properties of the shutter 22 and the leaf springs 23, 24 working as a spring and damper (mass of the shutter 22, spring constant of the leaf springs 23, 24, and damping coefficient of the leaf springs 23, 24). Accordingly, by properly setting these properties, it is possible to control the shift of the shutter 22 according to the stroke frequency of the piston rod 6. In the present invention, the mass of the shutter 22 and the spring constant and the damping force of the leaf springs 23, 24 are set as that the stroke frequency of the piston rod 6 allows minimum resistibility to the shift of the shutter 22 at a low frequency region around a sprung resonant frequency ω1 of a suspension device while allowing maximum resistibility at a high frequency region around an unsprung resonant frequency ω2 of the suspension device.

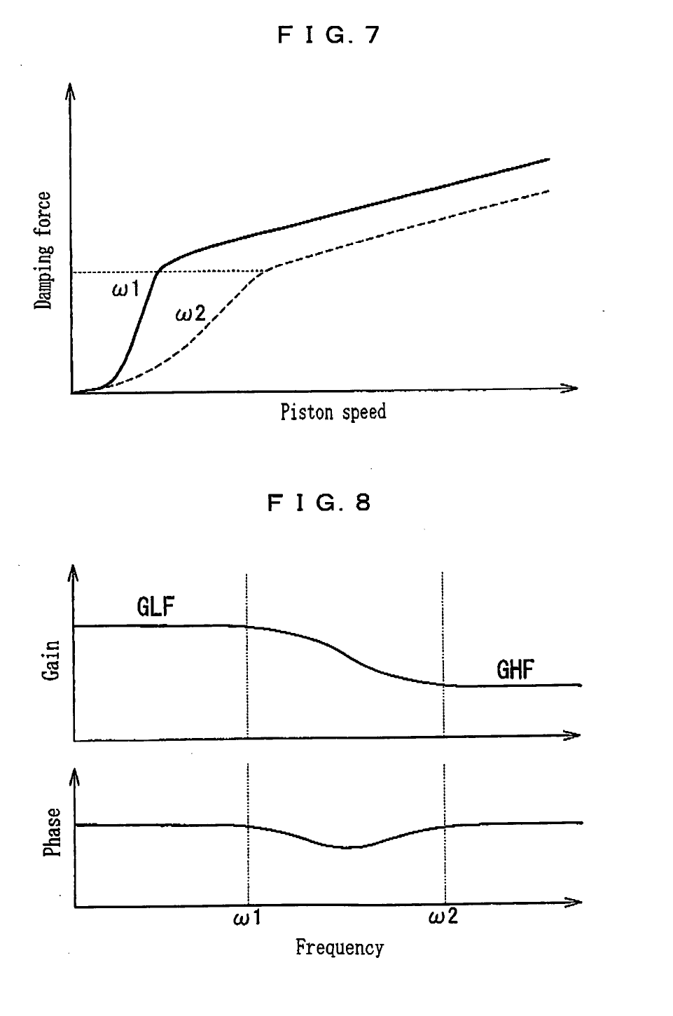

With the above structure, when the piston rod 6 starts strokes from its rest condition at the low frequency region around the sprung resonant frequency ω1, damping force having low orifice properties defined based on the flow passage area of the adjustable extension passage 32A provided between the extended guide groove 32 and the shutter groove 36 at an initial position of the shutter 22 will start to generate. Along with increase of stroke speeds, liquid force working on the shutter 22 will expands whereby the shutter 22 shifts in a direction of closing the adjustable extension passage 32A thereby enlarging the damping force of the orifice properties. Here, at the low frequency stroke region, resistibility due to the mass of the shutter 22 and the spring constant and the damping force of the leaf springs 23, 24 is limited. Accordingly, as shown in FIG. 7 with solid lines, the damping force will rapidly arise whereby pressure in the cylinder upper chamber 2A will reach to pressure to open the extension disk valve 13 along with increase of piston speeds. In case of making the stroke speed of the piston rod 6 decreased after reaching to the maximum speed, the shutter 22 will open its flow passage while the flow speed of the working fluid is lowered so as to reduce liquid force. Since damping force will be smoothly decreased to the end, the motion of a vehicle body will not be unstable.

In addition, in a case where the piston rod 6 makes strokes at the high frequency around the unsprung resonant frequency ω2, at the beginning of the strokes, damping force having low orifice properties that are determined by the passage area of the adjustable extension passage 32A placed between the extended guide groove 32 and the shutter groove 36 at the initial position of the shutter 22 will start to generate. Here, although piston speed will arise in a short period so as to increase fluid force working on the shutter 22, at stroke regions at a high frequency, resistibility due to the mass of the shutter 22 as well as the spring constant and the damping force of the leaf springs 23, 24 will expand. Accordingly, the shift of the shutter 22 becomes diminished whereby, as shown in FIG. 7 with broken lines, the damping force will arise smoothly so as to be able to sufficiently absorb unsprung vibrations. Here, the degree of inclination can be determined by the area of the notches 32B, 33B (shape, width, depth and number) and the properties of the leaf springs 23, 24.

Here, the shutter 22 is within the cylinder upper chamber 2A, and pressure working on the both end portions of the shutter 22 is normally stable. Further, since the shutter 22 does not apply pressure differences between the cylinder upper and lower chambers 2A, 2B as thrust force, there is no invalid stroke producing no damping force relative to the stroke of the piston rod 6 for the shift of the shutter 22. Accordingly, it is possible to quickly raise predetermined damping force and to inhibit late response or damping force insufficiency thereby obtaining stable damping force.

Next, a Bode diagram that shows a transfer function of damping force (output) relative to stroke frequencies (input) in a condition where speeds of the piston rod 6 of the shock absorber 1 is constant is shown in FIG. 8. At a region that is equal to or less than the sprung resonant frequency ω1, a gain GLF is high, and the gain is gradually lowered according to the increase of the frequency. At the unsprung resonant frequency ω2, the gain will reach to a gain GHF that is relatively low. Considering phase properties, some delays can be found between the sprung resonant frequency ω1 and the unsprung resonant frequency ω2. This is because that the shutter 22 shifts in a closed direction after the piston rod 6 strokes thereby expanding the damping force. The phase delay will return to null at a region beyond the unsprung resonant frequency ω2.

This gain curve based on the above frequency properties is adjustable by a natural frequency determined by the mass of the shutter 22 and the spring constant of the leaf springs 23, 24 as well as damping ratio of the leaf springs 23, 24. In this case, since the shutter 22 becomes a second-order lag system, by setting natural frequency near resonance frequencies of a vehicle body and also by setting damping ratio to be small, it is possible to make the gain to be high near the resonance frequencies of the vehicle body. The upper limit of the damping force of the valve properties will be determined by the extension disk valve 13 and does not exceed values of the solid lines shown in FIG. 7. However, damping effects can be enhanced if the gradient of the orifice properties is increased so as to make energies to be absorbed to be enlarged.

In the damping-force adjusting mechanism 19, in the compressed process of the piston rod 6, when working fluid flows from the compressed guide groove 33 to the extended guide groove passing through the shutter groove 36, the passage of the adjustable compression passage 33A placed between the compressed guide groove 33 and the shutter groove 36, and also the passage of the adjustable extension passage 32A placed between the shutter groove 36 and the extended guide groove 32 are drawn. Accordingly, its flow speed is increased so as to generate jet. By means of the get, fluid force will be generated so as to force the shutter 22 to move in a direction to close the passages. Based on the above, the fluid force generated at the adjustable compression passage 33A becomes larger than the fluid force generated at the adjustable extension passage 32A. Due to the difference of the fluid force, the shutter 22 moves upward as shown in FIG. 3(C) against the spring force of the leaf springs 23, 24 so as to close the adjustable compression passage 33a. Thus, as the same with the case of the above extension process, it is possible to adjust damping force according to the stroke frequencies of the piston rod 6.

As discussed above, in the damping-force adjusting mechanism 19, by draw of the adjustable extension passage 32A in a direction from the shutter groove 36 to the extended guide groove 32, damping force in the extended process of the piston rod 6 can be adjusted. Further, by the draw of the adjustable compression passage 33A in a direction from the shutter groove 36 to the compressed guide groove 33, damping force in the compression process of the piston rod 6 can be also adjusted. Accordingly, it would be possible to set damping force properties individually at either the extended side or the compressed side.

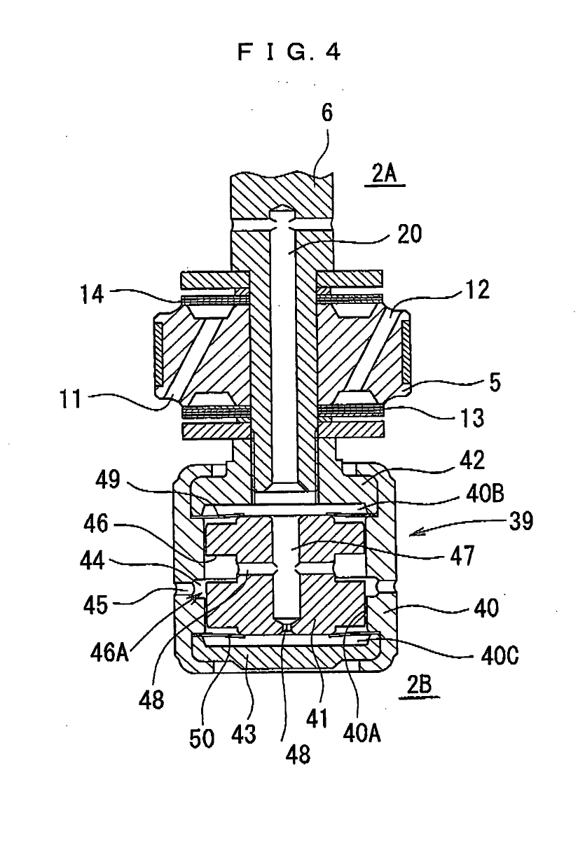

Next, a second embodiment of the present invention will be discussed with reference to FIG. 4. Here, parts that are the same with the first embodiment in FIGS. 1 and 2 will be denoted with the same reference numerals, and detail descriptions are given only to parts different therefrom.

In FIG. 4, a piston portion that is the main feature of a shock absorber according to this embodiment is shown. As shown, a damping-force adjusting mechanism 39 is mounted at the top end portion of the minor diameter of the piston rod 6 that penetrates the piston 5. In the damping-force adjusting mechanism 39, a shutter 41 is slidably fitted into a cylindrical shutter guide 40, and the opening portions placed on both ends of the shutter guide 40 are closed with a nut member 42 and a cap member 43. The nut member 42 and the cap member 43 are fitted into expanded-diameter portions placed on both sides of a guide portion 40A that guides the shutter 41 within the shutter guide 40. Further, the nut member 42 and the cap member 43 abut to the end portion of the guide portion 40A and fixed by caulking the end portion of the expanded-diameter portions of the guide portion 40A. Furthermore, the nut member 42 is screwed into the top end portion of the piston rod 6, and the interior of the shutter guide 40 is connected to the by-pass passage 20 of the piston rod 6.

At the inner peripheral portion of the shutter guide 40, a circumferential guide groove 44 is formed, and the guide groove 44 is connected to the cylinder lower chamber 2B by means of a path 45 provided on the lateral wall of the shutter guide 40. At the outer peripheral portion of the shutter 41, a circumferential shutter groove 46 is formed as to face the guide groove 44. Further, an axial passage 47 that penetrates the center portion of the shutter 41 in its axial direction is formed, and the axial passage 47 is connected to the shutter groove 46 by a radial passage 48. The axial passage 47 is provided with a damping orifice 48 as a damping means that provides damping force to the shift of the shutter 41.

The shutter 41 is elastically retained by leaf springs 49, 50 at an initial position of FIG. 4. As regards the spring 49, its outer peripheral portion is clamped between the one end portion of the guide groove 40A of the shutter guide 40 and the nut member 42 while its inner peripheral portion abuts to one end portion of the shutter 41. On the other hand, as regards the leaf spring 50, its outer peripheral portion is claimed between the other end portion of the guide portion 40A of the shutter guide 40 and the cap member 43 while its inner peripheral portion abuts to the other end portion of the shutter 41. The leaf springs 49, 50 are adapted to abut against the shutter 41 with an initial deflection and elastically retain the shutter 41 with a predetermined initial load. In a condition where the shutter 41 is retained at the initial position as described above, the shutter groove 46 and the guide groove 44 are lapped with each other so as to open an adjustable passage 46A placed between the shutter groove 46 and the guide groove 44. Further, the damping-force adjusting mechanism 39 is open-centered so as to shift the shutter 41 upward as shown in FIG. 4 thereby closing the passage. As the same with the first embodiment, it is possible to provide notches at the marginal portions of either the guide groove 44 or the shutter groove 46 so as to adjust passage properties.

With the structure discussed above, in the extended process of the piston rod 6, before the extension disk valve 13 is opened, working fluid on the side of the cylinder upper chamber 2A will flow into the shutter guide 40 by passing through the by-pass passage 20. Further, the working fluid then flows toward the side of the cylinder lower chamber 2B by passing through the axial passage 47, the radial passage 48, the shutter groove 46, the guide groove 44 and the path 45. At this time, due to the draw of the adjustable passage 46A in a direction from the shutter groove 46 to the guide groove 44, the damping force of the orifice properties will be generated.

On the other hand, in the compressed process of the piston rod 6, working fluid on the side of the cylinder lower chamber 2B will flow into the side of the cylinder upper chamber 2A by passing through the path 45, guide groove 44, the shutter groove 46, the radial passage 48, the axial passage 47, a shutter chamber 40B and the by-pass passage 20. At this time, due to the adjustable passage 46A in a direction from the guide groove 44 to the shutter groove 46, damping force will be generated.

Then, when flow of the working fluid starts to occur in the adjustable passage 46A placed between the guide groove 44 and the shutter groove 46, the flow will be jet due to the draw of the passage so as to generate fluid force whereby the fluid force will, against the spring force of the leaf springs 49, 50, act to move the shutter 41 in a direction to close the passage (toward the upper direction of FIG. 4). Here, in the present embodiment, in the extended process of the piston rod 6, the fluid force due to flow of the working fluid in a direction from the shutter groove 46 to the guide groove 44 will directly apply to the shutter 41 to move. On the other hand, in the compressed process, the fluid force due to flow of the working fluid in a direction from the guide groove 44 to the shutter groove 46 will directly apply to the shutter 41 to move.

Here, in the shift of the shutter 41, the inertial force (mass) of the shutter 41, the spring force of the leaf springs 49, 50, and damping force due to the draw of the damping orifice 48 relative to flow of working fluid that is generated at the axial passage 47 along with the shift of the shutter 41 are acted. Since the mass, the spring force and the damping force constitute a single-degree-of-freedom vibrating system as the same with the first embodiment, it is possible to control the shift of the shutter 22 according to the stroke frequencies of the piston rod 6 by properly setting these properties.

Since the shutter chambers 40B, 40C placed on either side of the shutter 41 within the shutter guide 42 are connected to each other by means of the axial passage 47, and also the shutter chamber 40B is connected to the cylinder upper chamber 2A by means of the by-pass passage 20, the shutter chambers 40B, 40C are in the same pressure that is identical with the pressure in the cylinder upper chamber 2A. Accordingly, considering the shutter 41, pressure applied to either end portion thereof is normally balanced. Further, since the shutter 41 does not apply pressure difference between the cylinder upper and lower chambers 2A, 2B as thrust force, there is no invalid stroke producing no damping force relative to the stroke of the piston rod 6 by the shift of the shutter 41. Accordingly, it is possible to raise damping force quickly and to inhibit late response or damping force insufficiency thereby obtaining stable damping force.

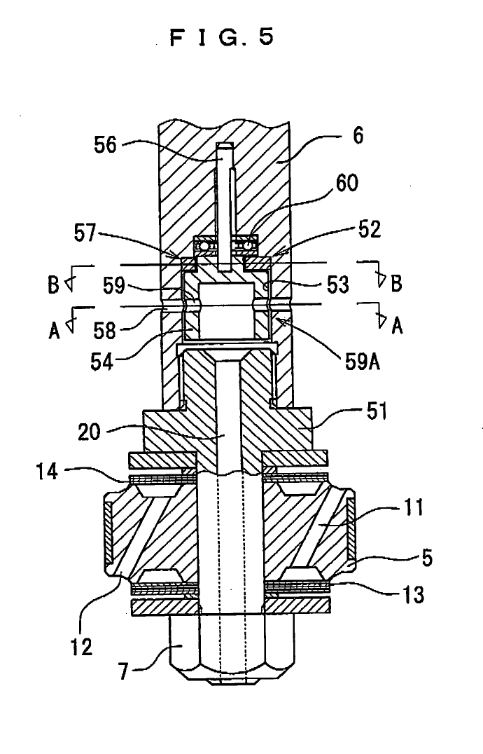

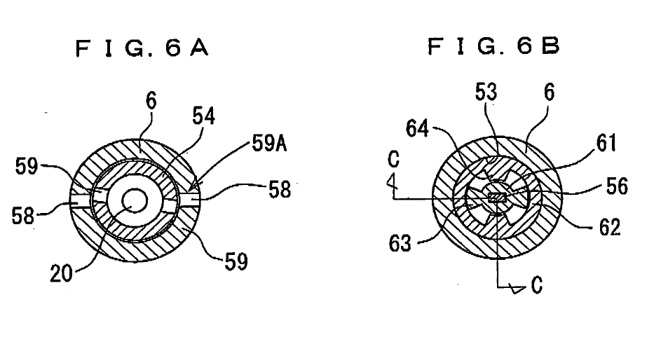

Next, the third embodiment of the present invention will be discussed with reference to FIGS. 5 and 6. Here, parts that are the same with the first embodiment in FIGS. 1 and 2 will be denoted with the same reference numerals, and detail descriptions are given only to parts different therefrom.

FIG. 5 shows a piston portion that is the main portion of a shock absorber according to the present embodiments. As shown in FIGS. 5 and 6, in the present embodiment, the piston rod 6 is connected to the piston 5 through a piston bolt 51, and a rotary damping-force adjusting mechanism 52 is provided in the interior of the piston rod 6. One side of the piston bolt 51 penetrates the piston 5 so as to fix to the piston 5 by means of the nut 7 while the other side thereof is fixed by being screwed into the end portion of the piston rod 6.

The damping-force adjusting mechanism 52 is composed of: a guide bore 53 provided along the axis of the piston rod 6; a rotational shutter 54, formed into a cylindrical closed-end configuration, that is slidably and rotatively fitted into the guide bore 53; a screwing spring 56 that is made of an elastic member and elastically retaining the rotational shutter 54; and a damping mechanism 57 as a damping means that affects damping force to the rotation of the rotational shutter 54.

The guide bore 53 is integrally formed with a screw portion into which the piston bolt 51 is screwed. Further, the guide bore 53 is connected to the by-pass passage 20 that axially penetrates the piston bolt 51. On the lateral wall of the guide bore 53, a guide port 58 is provided. On the lateral wall of the rotational shutter 54, a shutter port 59 is provided so as to face the guide port 58. Based on the above structure, according to the rotational position of the rotational shutter 54, the passage area of an adjustable passage 59A placed between the guide port 58 and the shutter port 59 will be adjusted. The plural number of the guide port 58 and the shutter port 59 are provided along a circumferential direction and are in a symmetric arrangement whereby the pressure of working fluid working on the rotational shutter 54 will be well balanced.

The rotational shutter 54 is rotatively supported by a thrust bearing 60 placed between the bottom portion of the rotational shutter 54 and the guide bore 53. One end of the screwing spring 56 is fixed to the guide bore 53 in such a manner that one end portion of the guide bore 53 is fixed to the bottom portion of the rotational shutter 54 in a rotational direction. On the other hand, the other end of the screwing spring 56 is connected to the piston rod 6 in a manner to be fixed in a rotational direction. Accordingly, the rotational shutter 54 is elastically retained at an initial position as shown in FIGS. 5 and 6. Moreover, when the rotational shutter 54 is at the initial position where the rotational shutter 54 is retained by the screwing spring 56, the guide port 58 and the shutter port 59 are lapped with each other so as to be open-centered where a pressed passage having a predetermined opening between the guide port 58 and the shutter port 59 is formed. In the damping mechanism 57, as best shown in FIG. 6(B), an annular chamber is formed between an axial portion 61 projecting outside of the bottom portion of the rotational shutter 54 and a ring-shaped damping plate 62 pressed into and fixed at the bottom portion of the guide bore 53. The annular chamber is then divided into 4 approximately fan-shaped chambers with a pair of approximately fan-shaped partitioned portions 63 extending in a diametrical direction from the outer peripheral portion of the axial portion 61 nearly up to the inner peripheral surface of the damping plate 62, and a pair of approximately fan-shaped partition portions 64 extending from the inner peripheral portion of the damping plate 62 nearly up to the external peripheral surface of the axial portion 61. These 4 fan-shaped chambers are connected with each other through clearance defined by: the partitioned portions 63, 64; the damping plate 62; and axial portion 61. In addition, these chambers are filled with working fluid. Thus, the working fluid flows through these 4 chambers through the clearance, and damping force will act by means of the flow resistance of the clearance.

By constructing the present embodiment as discussed above, in the extended process of the piston rod 6, before the extension disk valve 13 is opened, working fluid on a side of the cylinder upper chamber 2A will flow toward the cylinder lower chamber 2B by passing through the guide port 58, the shutter port 59, the interior portion of the rotational shutter 54, and the by-pass passage 20. At this time, damping force will generate due to the draw of the adjustable passage 59A in a direction from the guide port 58 to the shutter port 59.

On the other hand, in the compressed process of the piston rod 6, working fluid on a side of the cylinder lower chamber 2B will flow toward the cylinder upper chamber 2A by passing through the by-pass passage 20, the interior portion of the rotational shutter 54, the shutter port 59 and the guide port 58. At this time, damping force will generate due to the draw of the adjustable passage 59A in a direction from the shutter port 59 to the guide port 58.

Then, when flow of the working fluid starts to occur in the adjustable passage 59A placed between guide port 58 and the shutter port 59, the flow will be jet due to the draw of the passage so as to generate fluid force whereby the fluid force will, against the spring force of the screwing spring 56, act to move the rotational shutter 54 in a direction to close the passage (in a clockwise direction in FIG. 6(A)). Here, in the present embodiment, in the extended process of the piston rod 6, the fluid force due to flow of the working fluid in a direction from the guide port 58 to the shutter port 59 will directly apply to the rotational shutter 54 to rotate. On the other hand, in the compressed process, the fluid force due to flow of the working fluid in a direction from the shutter port 59 to the guide port 58 will directly apply to the rotational shutter 54 to rotate.

Here, the rotation of the rotational shutter 54 involves the moment of inertia by the mass of the rotational shutter 54, the spring force of the screwing spring 56, and damping force by the damping mechanism 57. Since the mass, the spring force and the damping force constructs, as the same with the first embodiment, a single-degree-of-freedom vibrating system, it is possible to control the shift of the rotational shutter 54 according to the stroke frequency of the piston rod 6 by properly setting these properties.

Since the rotation of the rotational shutter 54 does not apply pressure difference between the cylinder upper and lower chambers 2A, 2B as thrust force, there is no invalid stroke producing no damping force relative to the stroke of the piston rod 6 by the rotation of the rotational shutter 54. Accordingly, it is possible to raise damping force quickly and to inhibit late response or damping force insufficiency thereby obtaining stable damping force.

Here, the first embodiment applies damping force due to friction between laminated disks of the leaf springs 23, 24 to a shutter; the second embodiment applies damping force by the damping orifice 48 to a shutter; and the third embodiment applies damping force by the damping mechanism 57 to a shutter. However, it is possible to eliminate these damping means. Here, even in a case where the single-degree-of-freedom vibrating system including the shutter is constructed by only mass and spring elements, the shift of the shutter will be a first-order lag so as to enable to control damping force according to the stroke frequency of the piston rod 6.

In the first to the third embodiments, the present embodiment is explained in a case of a double-tube shock absorber having the reservoir 4; however, the present invention is not limited thereto. Instead, a mono-tube shock absorber where a gas chamber is formed by a free piston within a cylinder may be applied. Moreover, working fluid is not limited to working liquid; instead, it may be gas. In this case, the reservoir 4, the base valve 10 and the free piston, etc. will be not necessary. Here, in the discussed embodiments, the leaf springs as an elastic member vertically pinch the shutter, but only a single leaf spring may be applied.

What is claimed is:

1. A shock absorber comprising:
a cylinder where working fluid is filled in;
a piston that is slidably inserted into the cylinder and partitions the cylinder into two chambers;
a piston rod that is connected with the piston and externally projects from the cylinder;
a by-pass passage that passes through the two chambers in the cylinder; and
a damping-force adjusting mechanism that adjusts a passage area of the by-pass passage, wherein
the damping-force adjusting mechanism includes: a shutter guide provided at the piston rod; a shutter that is movably guided by the shutter guide; and an elastic member that elastically retains the shutter at an initial position,
an adjustable passage that adjusts the passage area of the by-pass passage as that opening is varied by shift of the shutter is formed,
shift of the shutter is not influenced by pressure difference between the two chambers in the cylinder, and
when the shutter is at the initial position, the adjustable passage is opened with a predetermined degree, and the shutter moves in a direction to close the adjustable passage by means of fluid force that generates by flow of the working fluid of the adjustable passage against elastic force of the elastic member.

2. The shock absorber according to claim 1, wherein the shutter guide is provided at an outer peripheral portion of the piston rod, and the shutter is a cylindrical member that is fitted into an external periphery of the shutter guide.

3. The shock absorber according to claim 1, wherein the adjustable passage is formed by a circumferential groove that is provided at least one of the shutter guide and the shutter.

4. The shock absorber according to claim 1, wherein the elastic member is arranged at either end portion of the shutter, and formed with a plurality of disk-shaped leaf springs that are laminated with each other.

5. The shock absorber according to claim 1, wherein the by-pass passage is arranged within the piston rod.

6. The shock absorber according to claim 1, wherein the shutter guide is a cylindrical member that is fixed to an end portion of the piston rod where the shutter is slidably guided into the shutter guide.

7. The shock absorber according to claim 1, wherein the shutter moves along the axial direction of the shutter guide.

8. The shock absorber according to claim 1, wherein the shutter is rotatable relative to the shutter guide.

9. The shock absorber according to claim 1, wherein a damping means is provided so as to apply damping force to shift of the shutter.

10. A shock absorber comprising:
a cylinder where working fluid is filled in;
a piston that is slidably inserted into the cylinder and partitions the cylinder into two chambers;
a piston rod that is connected with the piston and externally projects from the cylinder;
a by-pass passage that passes through the two chambers in the cylinder; and
a damping-force adjusting mechanism that adjusts a passage area of the by-pass passage, wherein
the damping-force adjusting mechanism includes a shutter that shifts on a passage of the by-pass passage so as to open or close the passage, and
the shutter is not externally controlled, is not influenced in movement by pressure difference between the two chambers in the cylinder, and moves by fluid force that is generated by flow of the working fluid.
